(19) United States
(12) Patent Application Publication
(10) Pub. No.: US 2024/0426414 A1
(43) Pub. Date: Dec. 26, 2024

(54) WRAPPING AND TENSIONING DEVICE

(71) Applicant: ENDURATEC LTD, Gloucester (GB)

(72) Inventor: Bruce Hutt, Gloucester (GB)

(21) Appl. No.: 18/749,957

(22) Filed: Jun. 21, 2024

(30) Foreign Application Priority Data
Jun. 23, 2023 (GB) 2309482.4

(51) Int. Cl. F16L 55/168; B65H 35/00; B65H 59/16

(52) U.S. Cl. CPC F16L 55/1686; B65H 35/0033; B65H 59/16; B65H 2404/152; B65H 2701/379

(57) ABSTRACT

A tape wrapping and dispensing device for wrapping stretchable tape around a pipe. The device has at least three tension rollers that are mounted at the dispensing end of a support plate, the tension rollers defining a first nip between an upper and intermediate roller and a second nip between the intermediate roller and a lower dispensing roller. In use, a free end of the stretchable tape can be removed from the supply roll and passed, first, between the first nip and then between the second nip before being secured to a pipe or other elongate body, and then, with the lower dispensing roller in direct contact with the stretchable tape secured to the pipe or other elongate body, the device can be moved in a first circumferential direction around the pipe to cause rotation of the lower dispensing roller and simultaneously dispense and wind the tape therearound.

### CROSS-REFERENCE TO RELATED APPLICATIONS

This application claims the benefit of, or priority to, United Kingdom Patent Application 2309482.4, filed on Jun. 23, 2023, which is hereby incorporated by reference in its entirety for all purposes.

### FIELD OF THE INVENTION

This invention relates generally to a method of repairing a leak in a pressurised fluid flow conduit, a venting tool for use in such a method, a wrapping and tensioning device for wrapping a stretchable material around a pipe or other elongate body, a high-tension dispenser including such a device, and a method of wrapping a stretchable tape around a pipe or other elongate body.

### BACKGROUND OF THE INVENTION

It is known to repair a leak in a pipe using a putty (e.g. silicon putty, a self-fusing or self-amalgamating tape and a composite outer covering that, when cured, forms a solid shell around the repair. For example, European Patent No. EP3273132 describes a method of repairing a fluid leak in a pipe or conduit, characterised in that the method comprises applying a layer of putty to the pipe or conduit at a location of the leak to seal it; wrapping, at tension, a self-amalgamating tape around the layer of putty to cover it; contacting a flexible sheet or tape with either a resin or water to activate a water-activated matrix component; and encompassing the self-amalgamating tape with the flexible sheet or tape such that the resin or water-activated matrix component binds with the flexible sheet or tape to form an outer shell with the flexible sheet or tape to substantially surround the joint.

In such a method, the self-fusing or self-amalgamating tape must be wrapped (or wound) around the pipe or conduit with a high tensile load applied to the tape. If the tape is applied manually, an operative locates the free end of the tape on the pipe or conduit, and then pulls the tape roll to apply a tensile load to the stretchable tape in order to stretch it. As the stretchable tape is stretched, the tape heats up as it undergoes elastic expansion.

The self-fusing property of this type of tape means that when it is wrapped over itself, the overlapping tape layers fuse together. For optimum fusing and sealing of the overlapping layers, the tape must be stretched by a considerable amount. Furthermore, the operative must ensure that the tape layers are pressed down so that they adhere sufficiently to make a strong enough seal to prevent leaks.

UK Patent No. GB2531030 describes a high tension tape dispenser that seeks to address these issues. Referring to FIGS. 1 and 2 of the drawings, a prior art tape wrapping and dispensing device incorporates a wrapping and tensioning device 10 comprising a main support member 20 and a base 30 mounted to a lower region of the support member 20. The support member 20 comprises a support plate 22 having a dispensing end 22a, a distal end 22 and a central region 22c. A roller arrangement 40 is provided at the dispensing end 22a, and a handle 24 is mounted to the distal end 22b.

The roller arrangement 40 comprises a triangular arrangement of three rollers, including two lower rollers 42, 44 and an upper, adjustable roller 46. The adjustable roller 46 is spring loaded, being resiliently biased toward the two lower rollers 42, 44. An adjustment mechanism, located at the dispensing end 22a of the support plate 22, operates to adjust the relative position of the adjustable roller with respect to the two lower rollers 42, 44. In use, the user can rotate the handle 52 in one direction to move the adjustable roller 46 toward the two lower rollers 42, 44 (to increase tension), and in the opposite direction to move the adjustable roller 46 away from the lower rollers 42, 44 (to decrease tension). In use, the operative can initially move the adjustable roller 46 away from the lower rollers 42, 44 to load the tape and then use the adjustment mechanism 50 to move the adjustable roller 46 into an optimum position (optimum tension) for the type of tape to be dispensed.

A carrier shaft 60 is rotatably mounted in a central section 22c of the support plate 22. The carrier shaft 60 has a four-sided external profile defining four side faces 62 and including four longitudinal, outwardly extending protrusions or ribs 64 that extend along the length of the shaft 60 and extend outwardly at an inclined angle (˜45°) to the radial direction.

A cylindrical take-up shaft 70 is rotatably mounted at the distal end 22b of the support plate 22, below the handle 24. The take-up shaft 70 includes at least one slot 72 extending longitudinally from the open end 74 of the shaft 70. A drive belt 68 links the carrier shaft 60 and the take-up shaft 70 and, in use, the drive belt 68 drives the take-up shaft 70 when the carrier shaft 60 is rotated.

The base 30 comprises a curved plate 32 having smooth lower surface, and a heel plate 34 mounted at a distal end. At least the dispensing end edge of the is smoothed to a rounded profile to minimise friction. The heel plate 34 is an L-shaped plate with a curved first section 34a having a curvature the same as that of the curved plate 32, and a second section 34b that extends at an angle (˜60°) to the first section 34a. The heel plate 34 can be fixed to the curved plate 32 in a plurality of positions by means of a plurality of through-holes 36 in the curved plate 32.

Referring to FIG. 3 of the drawings, there is illustrated a prior art high-tension tape dispenser comprising the tape wrapping and tensioning device of FIGS. 1 and 2 and a supply roll 110 loaded into the device. The supply roll 110 includes a self-fusing tape 114 with a backing layer 112. In order to load the supply roll 110 into the dispenser 100, the supply roll 110 is mounted onto the carrier shaft 60 and the free end of the backing layer 112 is secured into one of the slots 72 in the take-up shaft 70. The adjustment mechanism 50 is adjusted to alter the position of the adjustable roller 46 (away from the lower rollers 42, 44) to accommodate the stretchable tape 114 in the roller arrangement 40. The free end of the self-fusing tape 112 is passed firstly between a first roller pair, the distal lower roller 42 and the adjustable roller 46, and then subsequently between a second roller pair, the dispensing end lower roller 44 and the adjustable roller 46.

In use, and referring to FIG. 4 of the drawings, the dispenser 100 is positioned on a pipe 200, with the curved plate 32 and heel member 34 in contact with the outer circumferential surface of the pipe 200. The free end of the self-fusing tape 114 is secured to the surface of the pipe 200. The user then pulls on the handle 24 to move the dispenser in a circumferential direction A. As the dispenser travels around the circumference of the pipe 200, the self fusing tape 114 is released from the supply roll 110. As the tape 114 is pulled through the device, it is pulled across the dispensing end lower roller 44, thus causing it (and the supply roll 110 and carrier shaft 60) to rotate in a dispensing direction opposite to A. The rotation of the carrier shaft 60 drives the drive belt 68 which, in turn, drives the take-up shaft 70. As the take-up shaft 70 rotates, the backing tape 112 is removed from the self-fusing tape 114 and wound onto the take-up shaft 70.

The tape 114 passes through between the nip of the first roller pair 42, 46 and then between the nip of the second roller pair 44, 46. The first and second roller pairs squeeze or pinch the tape 114 and, as the user pulls on the handle 24, a tensile load is applied to the tape 114 to stretch it, the size of the tensile load being dependent on the tension, as determined by the location of the adjustable roller 46 in relation to the two lower rollers 42, 44. The stretched self-fusing tape 116 is dispensed from the dispensing outlet and applied to the pipe 200.

The dispenser is moved around the pipe 200 multiple times in a circumferential direction A. As the dispenser 100 is wound around the pipe 200, it is also advanced along a longitudinal direction so that the dispensed stretched tape 116 at least partially overlaps the previously applied tape. When the stretched self-fusing tape is wrapped over itself and pressed together, the overlapping tape layers fuse together. In respect of any portion of stretched tape 116 applied to the pipe 200, the required ‘pressing’ action will occur after a full revolution of the device 100, when the smoother dispensing end edge of the curved plate 32 is slid over that portion of the applied tape.

Whilst the above-described high-tension tape dispenser is effective in wrapping self-fusing tape around a pipe, there are some issues associated with it. Firstly, the rotation of the dispensing end lower roller 44 is in the opposite direction to the direction A of movement of the device 100 when it is being used. For this reason, the curved plate 32 is required, to ensure that the dispensing end lower roller 44 never contacts the wrapped surface (otherwise it would act as a ‘brake’, preventing smooth movement of the tensioning device over the surface of the pipe 200). The curved plate 32 adds weight and complexity to the device but, not only that, it must be maintained very precisely against the surface of the pipe 200 during use, as a slight deviation can result in the edges of the plate 32 catching and nicking/damaging the applied tape. In addition, the curved plate 32 creates additional friction, such that an increased pulling force by the operative is required.

Still further, there is a significant air gap between the stretched tape 116 being dispensed and the surface of the pipe 200, and that portion of the tape, once applied, won't be pressed onto the previously-applied layer until there has been a full revolution of the device around the pipe. If, in the meantime, the tape snaps or the supply roll 110 runs out, there may be up to a full revolution of tape that has not yet been pressed down, and could, therefore, unravel.

Aspects of the invention seek to address one or more of these and/or other problems associated with methods of repairing a fluid leak in a pipe or conduit.

### SUMMARY OF THE INVENTION

In accordance with an aspect of the invention, there is provided a tape wrapping and dispensing device for wrapping stretchable tape around a pipe or other elongate body, the device comprising:
a support plate having a dispensing end and a lower edge defining a tape dispensing outlet region and an opposing distal end;
a carrier shaft, extending from said support plate between said dispensing and distal ends, on which a supply roll of stretchable tape can be rotatably mounted;
at least three rollers mounted at the dispensing end of the support plate, the tension rollers being configured in a generally rectangular arrangement and comprising a lower dispensing roller immediately adjacent said tape dispensing outlet region, an upper dispensing roller and an intermediate roller located adjacent to, and between, the upper and lower dispensing rollers such that the upper dispensing roller and the intermediate roller define a first nip and the intermediate roller and the lower dispensing roller define a second nip;
wherein, in use, the free end of the stretchable tape can be removed from the supply roll and passed, first, between the first nip and then between the second nip before being secured to a pipe or other elongate body, and then, with the lower dispensing roller in direct contact with the stretchable tape secured to the pipe or other elongate body, the device can be moved in a first circumferential direction around said pipe or other elongate body to cause rotation of said lower dispensing roller in said first circumferential direction and simultaneously dispense and wind the tape therearound;
the tension rollers being configured to grip the stretchable tape, in use, such that the device applies a tensile load to the stretchable tape and the stretchable tape dispensed from the tape dispensing outlet is under tension, and the lower dispensing roller acts to press the stretchable tape onto the pipe or elongate body as it is dispensed.

Optionally, the device may further comprise a take-up shaft for receiving the backing layer which is removed from the stretchable tape.

Beneficially, the device may further comprise a handle member mounted at said dispensing end of said support plate.

In a preferred embodiment, at least one of the rollers may be resiliently or spring biased toward the other two rollers.

The device may, optionally, further comprise an adjustment mechanism which operates to adjust the relative position of at least one of the rollers relative to the other two rollers. In an embodiment, the adjustment mechanism may be configured to operate to adjust the relative position of the intermediate roller relative to the upper and lower dispensing rollers. Optionally, the adjustment mechanism may comprise a selectively movable actuator configured to adjust the position of the shaft of one of the rollers relative to the other two rollers.

In an embodiment, the adjustment mechanism may comprise an elongate selectively movable actuator mechanically coupled to the shaft of said intermediate roller, and a adjustment handle mechanically coupled to said movable actuator and configured to selectively move said shaft of said intermediate roller relative to said upper and lower rollers. Beneficially, the adjustment handle may be located adjacent the distal end of the support plate and said elongate actuator extends along said support plate from a location adjacent said adjustment handle to a location adjacent the shaft of said intermediate roller. In an embodiment, the adjustment handle may comprise a screw arrangement mechanically coupled to said elongate actuator and a rotatable adjustment handle coupled to said screw arrangement and operable to adjust the position of the intermediate roller.

Beneficially, the device may further comprise a base roller mounted on the support plate adjacent its distal end and on the same edge as said tape dispensing outlet region, the base roller being arranged and configured such that, in use, the base roller can be placed in direct contact with the pipe or other elongate body, or previously wrapped layers of stretchable tape thereon, and caused to rotate in said first circumferential direction as the device is moved around the pipe in said first circumferential direction.

In an embodiment, the device may further comprise a handle arrangement mounted to the support plate at its distal end. The handle arrangement may, for example, comprise a pair of handle members mounted on said support plate and at least one of said handle members being selectively movable relative to the other handle member and/or the support plate.

The device may, beneficially, further comprise a removable housing configured to be removably mountable to the support plate over at least said carrier shaft and said rollers.

In accordance with another aspect of the invention, there is provided a high tension tape dispenser including a tape wrapping and dispensing device substantially as described above, and a supply roll of self-fusing tape mounted on the carrier shaft.

In accordance with another aspect of the invention, there is provided a method of wrapping a stretchable tape around a pipe or other elongate body, the method including:
taking a tape wrapping and tensioning device substantially as described above;
mounting a supply roll of stretchable tape onto the carrier shaft;
passing a free end of the stretchable tape, first, between said upper dispensing roller and said intermediate roller and then between the intermediate roller and the lower dispensing roller, before securing the free end of the stretchable tape to the surface of the pipe or elongate body;
positioning the device on the exterior surface of the pipe or elongate body such that the lower dispensing roller engages with the free end of the stretchable tape secured said exterior surface;
pulling the device in a first circumferential direction to dispense and stretch the tape, pressing the lower dispensing roller onto the stretchable tape as it is dispensed, and thus winding the tape around the pipe or elongate body; and
continuing to wrap the tape around the pipe in overlapping layers to cover a surface area of the pipe or elongate body.

In an embodiment, the stretchable tape may be a self-fusing or self-amalgamating tape.

In accordance with yet another aspect of the invention, there is provided a venting tool for use in a method of repairing a fluid leak in a fluid flow pipe, the venting tool comprising an elongate rigid bar having a proximal end and a longitudinally opposing distal end, the bar having a flat longitudinal base and an upper that tapers in height from said proximal to said distal end, the tool further comprising a rigid block at its proximal end, said block having a planar base substantially flush with the flat base of the bar and defining a striking surface adjacent to said proximal end and facing said bar, wherein a longitudinal groove or recess extends along the length of the bases of the bar and the block.

In an embodiment, the depth of said groove or recess may taper from the proximal end of the bar to its distal end.

Beneficially, the upper of said bar may be rounded.

The bar and/or said block may, for example, be formed of solid metal.

In accordance with another aspect of the invention, there is provided a method of repairing a fluid leak in a fluid flow pipe, comprising:
taking a venting tool substantially as described above;
placing said venting tool longitudinally on the exterior surface of a pipe with said distal end of the bar nearest the leak;
applying, in a repair region at the location of the leak, a layer of putty to the exterior surface of the pipe and the bar of the venting tool;
wrapping, at tension a self-fusing or self-amalgamating tape around said layer of putty to cover it and at least a portion of the length of the bar;
removing said venting tool from the repair region by applying a force to the striking surface of the block of the venting tool; and then
encompassing the repair region with a resin- or water-activated flexible sheet or tape to form an outer shell around the repair region.

These and other aspects of the invention will be apparent from the following Detailed Description.

### BRIEF DESCRIPTION OF THE DRAWINGS

Embodiments of the present invention will now be described, by way of examples only, and with reference to the accompanying drawings, in which:

FIG. 1 is a schematic perspective view of a tape wrapping and tensioning device according to the PRIOR ART;

FIG. 2 is a schematic side view of the device of FIG. 1;

FIG. 3 is a schematic side view of a high-tension tape dispenser according to the PRIOR ART;

FIG. 4 shows the device of FIG. 3 used to wrap self-fusing tape onto a pipe;

FIG. 5 is a perspective view of a tape wrapping and tensioning device according to an exemplary embodiment of a first aspect of the present invention, with the cover removed;

FIG. 6 is a rear view of the tape wrapping and tensioning device of FIG. 5;

FIG. 7 is a front view of the tape wrapping and tensioning device of FIG. 1, with the cover secured over the front (‘inner’) surface of the support plate;

FIG. 8 is a perspective view of the tape wrapping and tensioning device of FIG. 7;

FIG. 9 is a front view of a tape wrapping and tensioning device of FIGS. 5 to 8, with the cover removed and with a supply roll loaded on the carrier shaft, illustrating the method of operation of the device;

FIG. 10 is a schematic side perspective view of a venting tool according to an exemplary embodiment of another aspect of the invention;

FIG. 11 is a schematic bottom view of the venting tool of FIG. 10;

FIG. 12 is a perspective bottom view of the venting tool of FIG. 10;

FIG. 13 is a schematic rear view of the venting tool of FIG. 10;

FIG. 14 is a schematic perspective partial view of a pipe, indicating a leak and placement of a venting tool in a method of repairing the leak;

FIG. 15 is a schematic partial view of the pipe of FIG. 14, wherein a layer of uncured silicone putty has been applied over the leak and surrounding repair region; and

FIG. 16 is a schematic partial view of the pipe of FIG. 15, wherein layers of stretched self-fusing tape have been applied around the putty to encapsulate and mould the putty in the repair region.

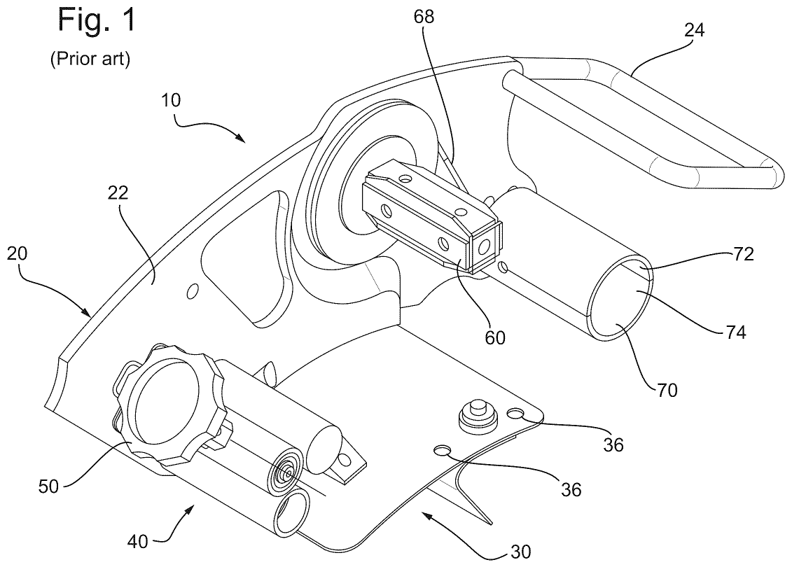

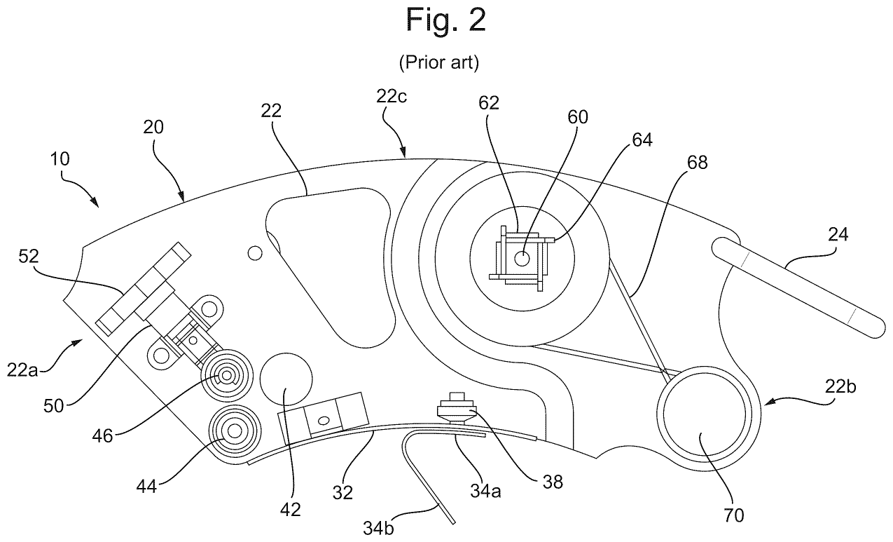

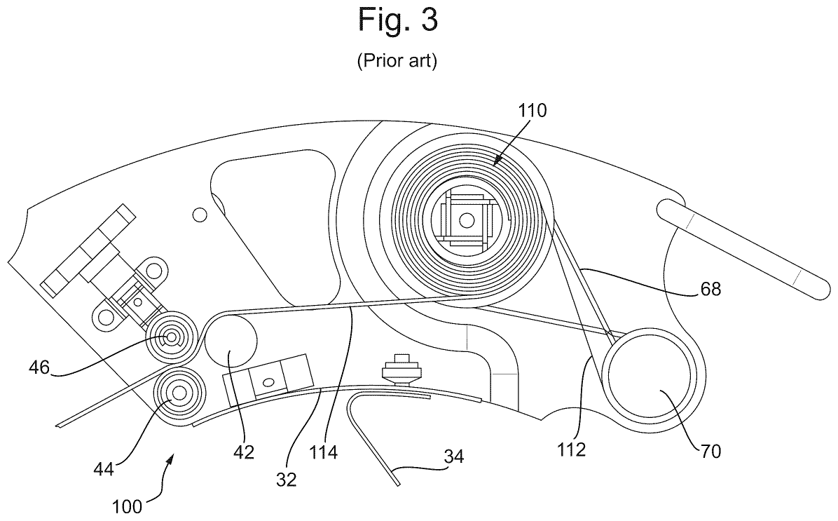

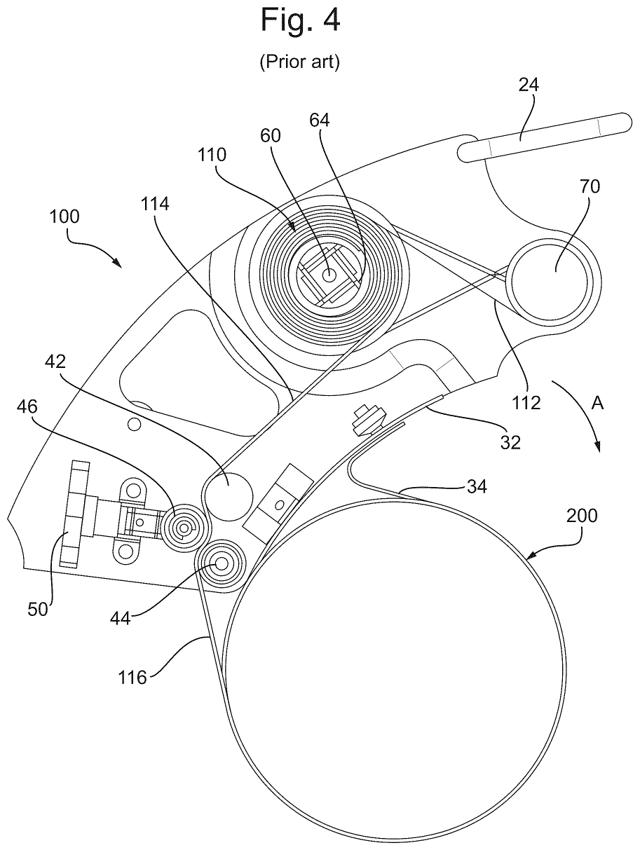

### DETAILED DESCRIPTION OF THE INVENTION

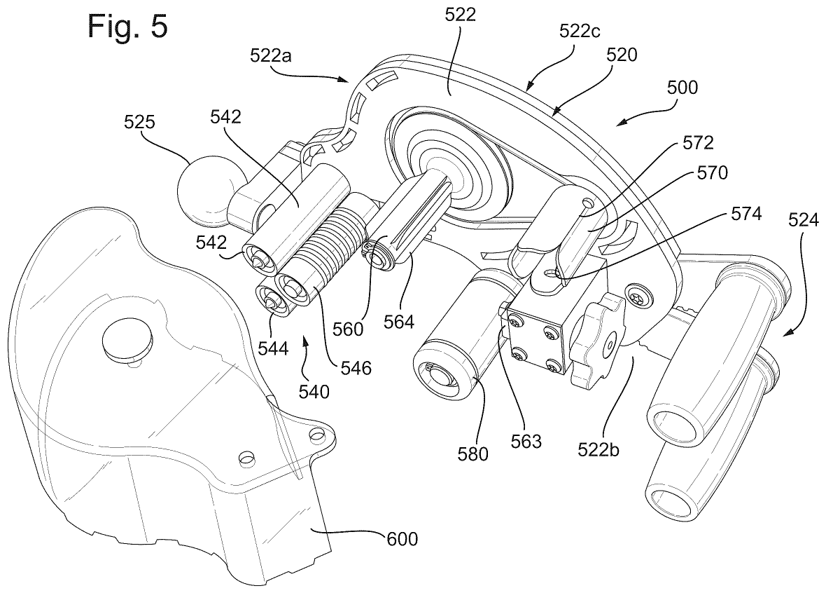

Referring to FIG. 5 of the drawings, an example wrapping and tensioning device 500 comprises a main support member 520 formed of a rigid material such as metal (e.g. stainless steel) or rigid plastic. The support member 520 comprises a support plate 522 having a dispensing end 522a, a distal end 522b and a central section 522c. A roller arrangement 540 is provided at the dispensing end 522a, and a first handle arrangement 524 is mounted at the distal end 522b. A second handle member 525 is mounted to the dispensing end 522a of the support plate 522.

The roller arrangement 540 comprises a triangular arrangement of three rollers, including an upper roller 542, a lower roller 544 and an intermediate (adjustable) roller 546, the axes of the upper and lower rollers 542, 544 being substantially in-line and parallel to each other and the axis of the intermediate roller 546 being laterally parallel to, but longitudinally offset from, the axes of the upper and lower rollers 542, 544. The upper and lower rollers 542, 544 are immediately adjacent the edge of the support plate 522 at its dispensing end 522a, whereas the intermediate roller 546 is located slightly in from the (dispensing) edge of the support plate 522, adjacent to and between the upper and lower rollers 542, 544. The intermediate roller 546 (at least) has, on its outer surface, a frictional coating or other means for increasing the friction coefficient of its outer surface. For example, a plurality of rubber (or other) rings may be inlaid in concentric spaced-apart grooves along the length of the outer surface of the roller 546. Other means of increasing the friction coefficient of the outer surface of the intermediate (or other) roller(s) will be apparent to a person skilled in the art, and the present invention is not necessarily intended to be limited in this regard.

The upper and lower rollers 542, 544 are mounted on respective elongate shafts that are fixed to the support plate 522, and extend from its ‘inner’ surface, substantially at right angles to its plane.

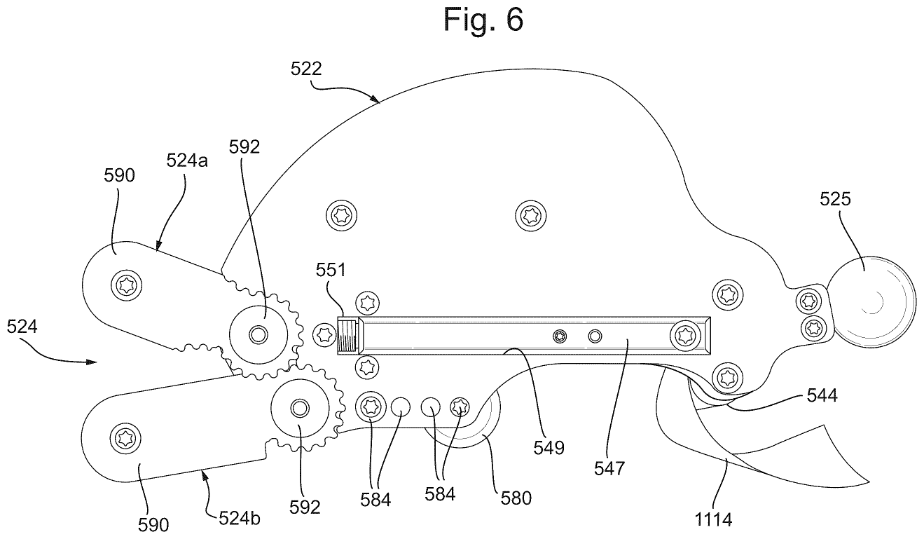

Referring additionally to FIG. 6 of the drawings, the shaft of the adjustable roller 546 is mechanically coupled to a proximal end of an elongate arm 547 slidably mounted within an elongate slot 549 in the ‘outer’ (or ‘rear’) surface of the support plate 522. The elongate slot 549 is longer than the elongate arm 547 by an adjustment portion 551, and extends from a location just in from the dispensing end 522b of the support plate 522 to a location closer to the dispensing end 522a of the support plate 522. The opposite, distal end of the elongate arm 547 is fixed to (or integrated with) a shorter leg portion 553 that extends at substantially a right angel from the distal end of the elongate arm 547, through the slot 549, and sits in a longitudinal recess 555 provided in the ‘inner’ surface of the support plate 522. The shorter leg portion 553 is coupled to an adjustment member 550 configured to selectively move and affix the shorter leg portion 553 along the length of the recess 555, thereby allowing longitudinal movement of the elongate arm 547 along the adjustment portion 551 of the elongate slot 549 and thus, in turn, allowing adjustment of the distance between the intermediate roller 546 (hereinafter referred to as the adjustable roller 546) and the upper and lower dispensing rollers 542, 544. In an example, the leg portion 553 may be mounted in the recess 555 via a longitudinal screw having, at its free end, an adjusting handle 550 which can be rotated in a first direction to move the leg portion 553 and the elongate arm 547 toward the distal end 522b of the support plate 522, thereby moving the adjustable roller 546 away from the upper and lower dispensing rollers 542, 544, and in a second, opposite, direction to move the adjustable roller 546 closer to the upper and lower dispensing rollers 542, 544. However, it will be appreciated by a person skilled in the art that other methods of effecting this longitudinal movement could be used, and the present invention is not necessarily intended to be limited in this regard. A benefit of having the adjustable roller 546 furthest from the dispensing end 522a of the support plate 522 (relative to the upper and lower rollers 542, 544) and utilising an elongate adjustment means (arm 547) that extends to, and is operated by, a mechanism at a location closer to the distal end 522b of the support plate 522 is that the adjustment handle 550 (or other means) can be located well away from the dispensing end 522a of the support plate 522. It also means that a housing 600 (to be described hereinafter) can be provided over the ‘inner’ surface of the support plate 522 that completely covers the upper roller 542 and the adjustable roller 546 and partially covers the lower roller 542 to help to prevent the ingress of dust and other contaminants to the exposed tape 1114, in use. Moreover, by arranging the rollers 542, 544, 546 in this way, a number of significant advantages relative to the prior art device are achieved. Firstly, as will be appreciated hereinafter, the tape can be laid directly onto the pipe and simultaneously pressed down by the lower dispensing roller 544. Furthermore, and again as will be appreciated hereinafter, the lower dispensing roller 544 rotates in the same direction of travel of the device around a pipe, in use, thus eliminating the need for the curved plate (32) of the prior art device and allowing the tape 1114 to be laid directly onto the pipe from the dispensing arrangement 540.

A carrier shaft 560 is mounted in a central region 522c o the support plate 522, and extends from its ‘inner’ surface, substantially at a right angle to its plane. The carrier shaft 560 has a generally circular cross-section and is configured to rotate in the direction of travel of the dispensing device around a pipe, in use. A number (e.g. three, or more) of longitudinal, outwardly extending protrusions or ribs 564 extend radially outward and along the length of the carrier shaft 560.

An open-ended cylindrical take-up shaft 570 is rotatably mounted closer to the distal end 522b of the support plate 522 than the carrier shaft 560. The take-up shaft 570 is substantially longitudinally in line with the carrier shaft 560 and extends substantially parallel thereto, again from the ‘inner’ surface of the support plate 522. The take-up shaft 570 includes at least one slot 572, extending longitudinally from the open end 574 of the shaft 570. A drive mechanism in the form of a drive belt 568 links the carrier shaft 560 and the take-up shaft 570 when the carrier shaft 560 is rotated, in use. Thus, in use, the take-up shaft 570 also rotates in the direction of travel A of the device as is wound around a pipe, in use.

A base roller 580 is mounted at a lower portion of the support plate 522, close to the distal end 522b. The base roller 580 is rigidly mounted to the support plate 522 via a short arm 582 and configured such that its axis of rotation is parallel to that of the dispensing rollers 542, 544, 546, the carrier shaft 560 and the take-up shaft 570. As can be seen in FIG. 6 of the drawings, the base roller 580 can be mounted in one of a number of positions along the length of the support plate 522, as defined by a plurality of spaced apart mounting holes 584 extending linearly from a location adjacent to where the first handle arrangement 524 is mounted at the distal end 522b of the support plate 522 to a location approximately below the outer circumferential edge of the carrier shaft 560. This allows the position of the base roller 580 to be selectively adjusted to suit a variety of pipe diameters.

The first handle arrangement 524 comprises a pair of handle members 524a, 524b. Each handle member 524a, 524b comprises an elongate arm 590 affixed, by fixing means 592 at one end, to the distal end 522b of the support plate 522. The fixing means 592 are arranged and configured to provide a rigid connection between the respective arm 590 and the support plate 522 when the device is in use, and to allow pivoting thereof, about an axis substantially parallel to the axes of rotation of the dispensing rollers 542, 544, 546, the carrier shaft 560 and the take-up shaft 570, when the respective fixing means 592 is released, so that the handle members 524a, 524b can be adjusted to suit the user. The fixing means 592 could, for example, comprise a captive thumb screw, but other suitable fixing means will be apparent to a person skilled in the art, and the present invention is not necessarily intended to be limited in this regard. The ends of the handle arms 592 at which they are affixed to the support plate 522 are rounded and comprise cooperative cog mechanisms that permit limited cooperative movement of the handle arms 590 relative to each other when the respective fixing means 592 is/are released. A handle bar 594 is provided at the distal (free) end of each handle arm 592, each handle bar 594 extending at substantially a right angle to the respective handle arm 592.

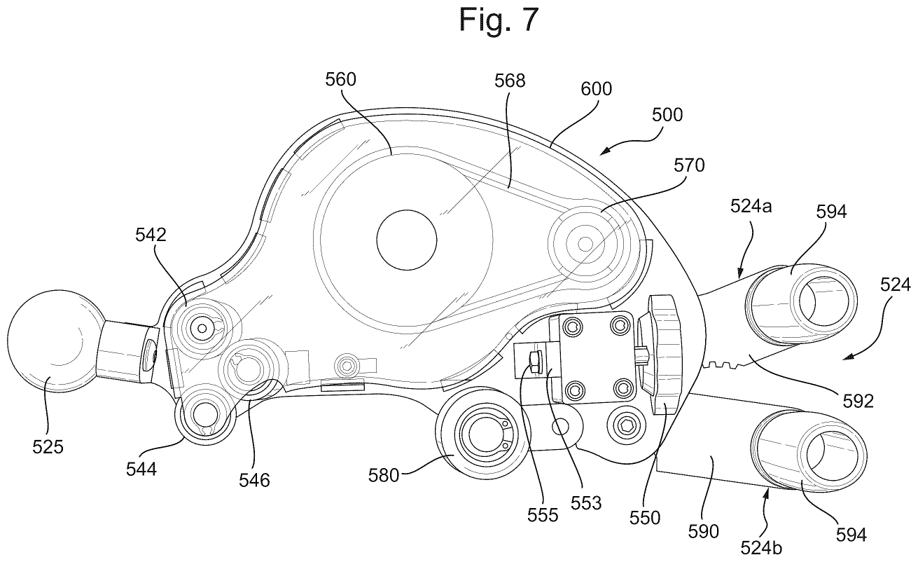

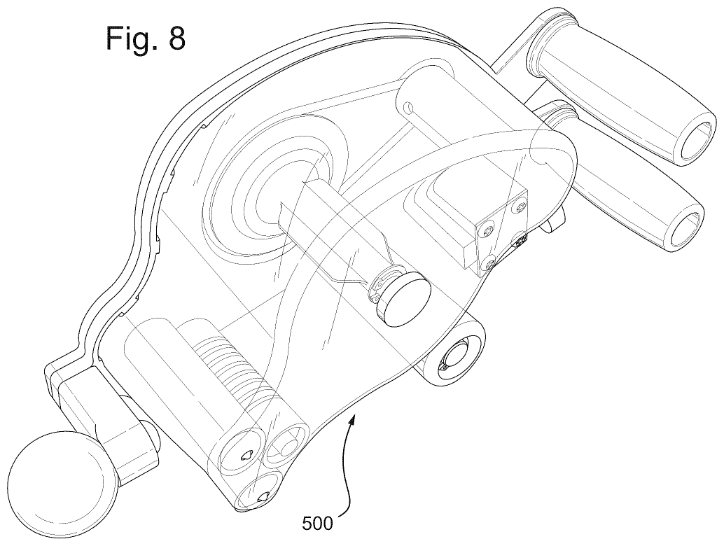

Referring additionally to FIGS. 7 and 8 of the drawings, a removable, rigid (e.g. rigid plastic) cover 600 fits onto the support plate 522, over the dispensing rollers 542, 544, 546 (leaving the lower edge of the lower dispensing roller 544 exposed), the carrier shaft 560 and the take-up shaft 570. The cover 600 may be removably affixed to the support plate 522 by means of a single releasably fixing (e.g. a thumb screw) at the centre of the carrier shaft 560. However, other fixing means and methods for removably attaching the cover 600 to the support plate 522 will be apparent to a person skilled in the art, and the present invention is not necessarily intended to be limited in this regard.

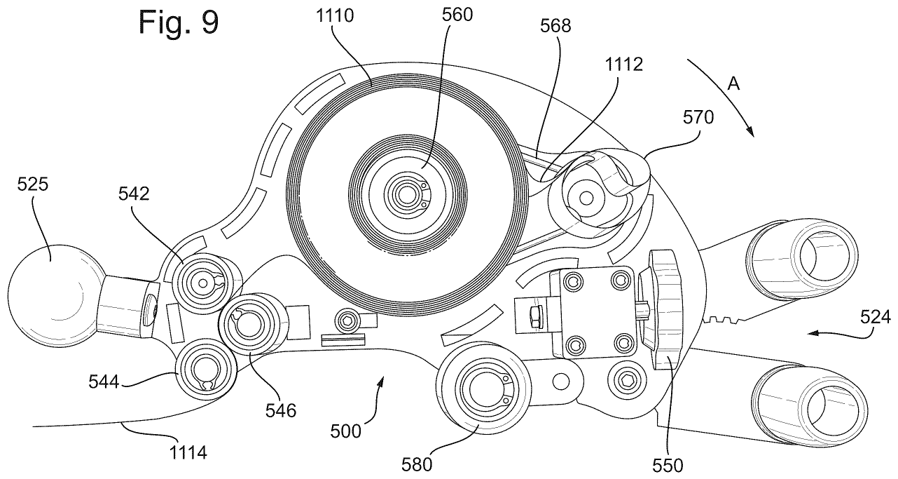

Referring now additionally to FIG. 9 of the drawings, in use, and with the cover 600 removed, a supply roll 1110 (of stretchable, self-fusing tape) is mounted on the carrier shaft 560 such that the leading edge (or free end) is over-oriented relative to the take-up shaft 570 (i.e. it comes over the top of the supply roll 1110 to the take-up shaft 570). The backing tape 1112 at the free end of the supply roll 1110 is secured into one of the slots 572 on the take-up shaft 570. The adjustment mechanism 550 is adjusted to move the adjustable roller 546 away from the other two dispensing rollers 542, 544 to allow the free end of the stretchable tape 1114 to be fed, first between the adjustable roller 546 and the upper dispensing roller 542 and then, subsequently, between the adjustable roller 546 and the lower dispensing roller 544, as illustrated in FIG. 9 of the drawings. The adjustable roller 546 can then be moved back (using the adjustment mechanism 550) toward the other two rollers 542, 544 to capture and press the stretchable tape 1114, and the cover 600 can then be replaced and secured to the support plate 522.

The position of the base roller 580 is adjusted in relation to the diameter of the pipe to be wrapped. In general, of use with larger pipes, the base roller 580 can be moved toward the distal end 522b of the support plate 522, and for use with smaller diameter pipes, the base roller 580 can be moved closer to the dispensing end 522a of the support plate, by means of the mounting holes 584 in the support plate 522.

The dispenser 500 is positioned on a pipe, with the free end of the stretchable tape 1114 (beneath the lower dispensing roller 544) on the outer surface of the pipe and the base roller 580 in contact with the exterior surface of the pipe. Thus, the free end of the stretchable tape 1114 is secured to the surface of the pipe and pressed in place by the lower dispensing roller 544 as the user presses downward on the dispenser via the first and/or second handles 524, 525 from the start of the wrapping process. The user pulls on the first handle arrangement 524 (and/or or the housing 600) to move the dispenser 500 in a circumferential direction A, whilst pressing downward with the second handle 525, to wrap self-fusing tape 1114 around the pipe. As the supply roll 1110 is pulled from the free end by the wrapping process, the supply roll 1110 rotates in a dispensing direction (the same direction as A) and the ribs 564 on the carrier shaft 560 cause the carrier shaft 560 to also rotate in the same direction A. The rotation of the carrier shaft 560 drives the drive belt 568 which, in turn, drives the take-up shaft 570. As the take-up shaft 570 rotates, the backing tape 1112 is removed from the self-fusing tape 1114 and wound onto the take-up shaft 570.

The tape 1114 passes through the nip of the first dispensing roller pair 542, 546 and then between the nip of the second dispensing roller pair 546, 544. The first and second roller pairs squeeze or pinch the tape 1114 and the tension can be adjusted as required by moving the adjustment roller 546 via the adjustment mechanism 550. As the tape passes through the dispensing roller pairs, the upper roller 542 rotates in the same direction as A, the adjustable roller rotates in the opposite direction and the lower roller 544 rotates in the direction A. One of the principal advantages of arranging the dispensing rollers in this way, and feeding the tape through them in the manner described, is that the lower dispensing roller rotates in the same direction as the direction of travel A of the device, which eliminates the need for the curved plate (32) of the prior art and allows the tape to be directly applied and pressed onto the pipe, in contrast with the prior art, wherein the dispenser must complete a full revolution around the pipe before the leading edge of the curved plate acts to press the tape onto the pipe.

The user pulls on the handle arrangement 524 (or cover 600) in the direction A and a tensile load is applied to the tape, immediately adjacent the lower dispensing roller 544 to stretch the next bit of tape immediately before it is applied and pressed onto the pipe by the lower dispensing roller 544. The dispenser 500 is moved around the pipe in the circumferential direction A, with the base roller 580 always in contact with the pipe to ensure consistent wrapping and to reduce friction, as well as acting to further firmly press the wrapped layers of self-fusing tape together. As the dispenser 500 is wound around the pipe, it is also advanced along the longitudinal direction so the tape stretched and applied to the pipe in each revolution of the dispenser 500 at least partially overlaps the previously applied tape. When the stretched self-fusing tape is wrapped over itself, the overlapping tape layers fuse together.

He tensioning and dispensing device 500 could be used in a method of repairing a leak in a fluid flow pipe, such as that described in European Patent No. 3273132. In the prior art method described therein, a method of creating a permanent repair in respect of a fluid leak in a pipe comprises a number of stages. Once the location of the leak has been properly cleaned and prepared, an uncured silicone putty is applied and manually pushed and manipulated into the leak and surrounding region. Next a self-fusing or self-amalgamating tape is wrapped, under tension, around the repair region, enveloping the putty around the leak. Finally, an ‘armour’ layer is applied, e.g. a water-activated glass fibre bandage, over, and beyond the edges of, the tape region, to form a puncture proof barrier.

The above-described method can work well for many different types of fluid leak. Medium pressure gas leaks are one of the most common types of fluid leaks that require permanent and effective repairs and, although the above-described method of repair can be used, issues can arise when the putty and self-fusing tape are applied (and before sufficient tape has been applied to hold and mould the putty in place and seal the leak), whereby they can ‘bubble’ up and come away from the leak as medium pressure gas escapes.

Accordingly, there is a need for an improved method of permanently repairing fluid leaks in pipes, especially (although not necessarily exclusively) medium pressure gas leaks in pipes.

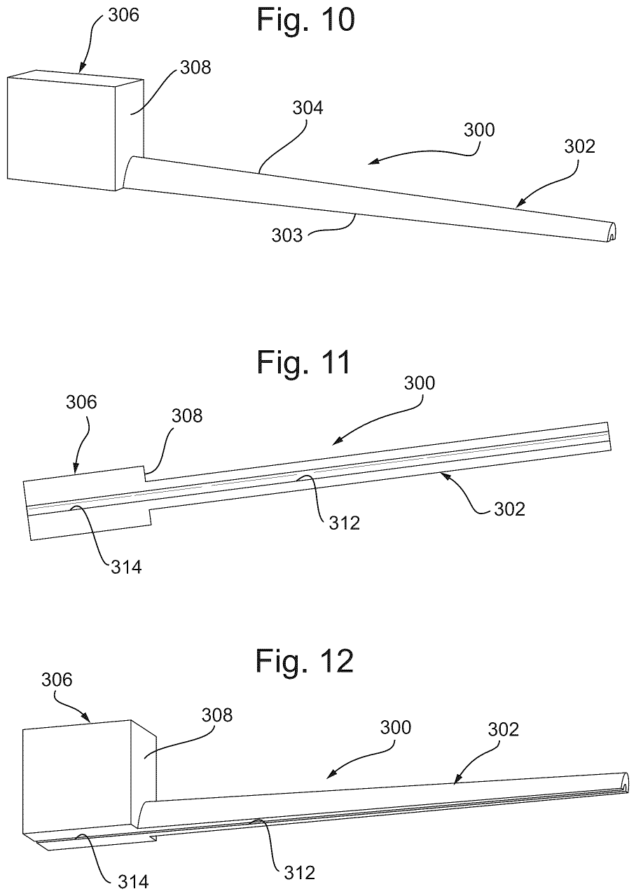

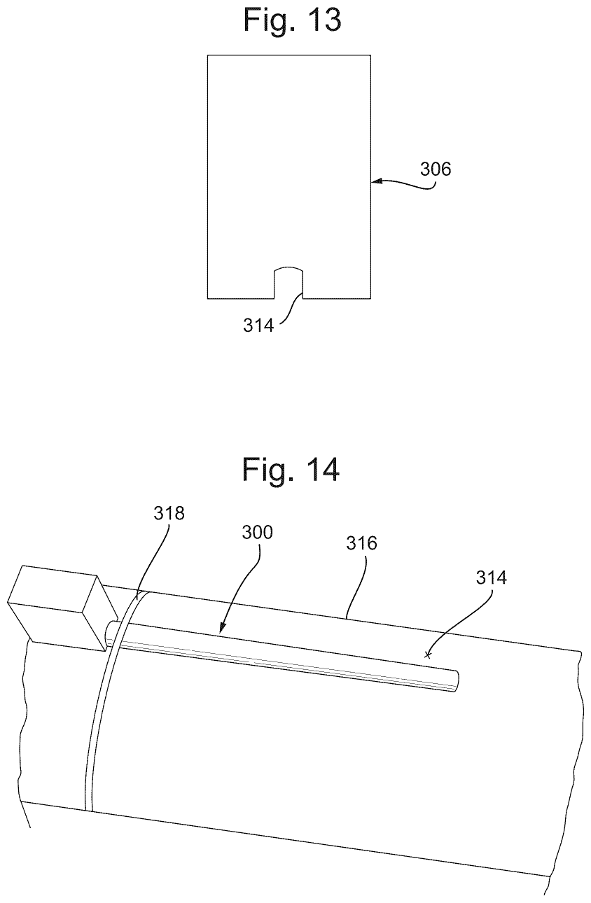

The inventors have devised a novel venting tool for use in a method of permanently repairing a fluid leak in a pipe. Referring to FIGS. 10, 11, 12 and 13 of the drawings, an example venting tool 300 comprises a rigid elongate bar 302 having a planar base 303 and a rounded upper 304. The thickness of the bar 302 gradually increases along its length from its (thinnest) distal end to its thickest (proximal) end. The bar 302 is, at its thickest (proximal) end, affixed to, or integrated with, a rigid block 306 having side edges that extend beyond the side edge of the bar 302. The bottom face of the block 306 is flush with the planar base 303 of the bar 302 and the height of the block 306 (beyond the top of the rounded upper 304 of the bar 302) is sufficiently large such that the face 308 of the block 306 immediately adjacent and facing the bar 302 forms a striking surface that can be struck with, for example, a hammer or the like. Thus, the bar 302 can be formed of a rigid, durable material such as plastic or metal (e.g. stainless steel), for example, but the block 306 requires that at least its striking face 308 can withstand a large force. The block 306 could, for example, be formed of solid stainless steel or the like.

An elongate recess or groove 310 extends generally centrally along the length of the planar base 303 of the bar 302, from the thinnest distal end to the proximal end abutting the block 306. The groove may gradually increase in height from the distal end of the bar 302 to its proximal end, as the thickness of the bar gradually increases. However, it could, in other embodiments, be of substantially uniform height (or depth) along its length.

A similar groove 312 is also provided in the base of the block 306, extending across its entire depth from the striking face 308 to the opposing ‘rear’ face of the block 306. Once again, the depth of the groove 312 in the block 306 could gradually increase from the striking face to the rear face, thus matching the profile of the groove 310 in the bar 302, or it could be of substantially uniform depth. Either way, the groove 310 in the bar and the groove 312 in the block 306, together, form a continuous, open-ended channel that extends longitudinally through the entire length of the venting tool 300, from the distal end of the bar 302 to the rear face of the block 306.

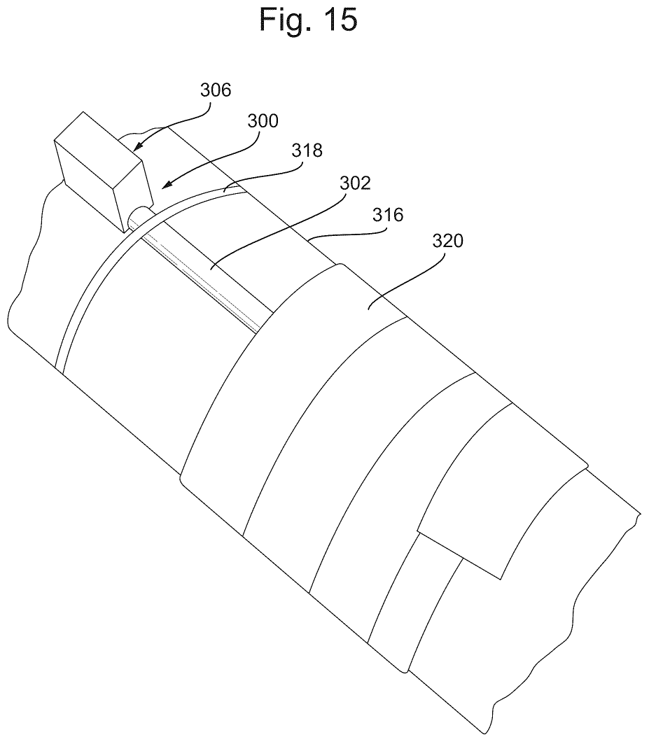

In use, and referring to FIG. 14 of the drawings, in a method for repairing s leak 314 in a pipe 316 carrying gas at medium pressure, for example, an operative first cleans and prepares the repair region around the leak by removing rust and debris (e.g. using a wire brush) and possibly sanding the region, before cleaning thoroughly (e.g. using water) and drying.

Next, a venting tool 300 of the type described above is placed on the pipe 316 with the distal (thinner) end of the bar 302 close to (and extending just beyond) the leak 314, and a single wrap 318 of tape is wound around the pipe 316 and the venting tool 300 close to the proximal (thickest) end of the bar 302, to hold the tool 300 in place.

Next, referring to FIG. 15 of the drawings, uncured (silicone) putty ‘tape’ 320 (˜1-2 mm thick) is wound around the pipe 316 and bar 302 of the venting tool 300, covering (and extending beyond) the leak 314 and the distal end of the bar 302.

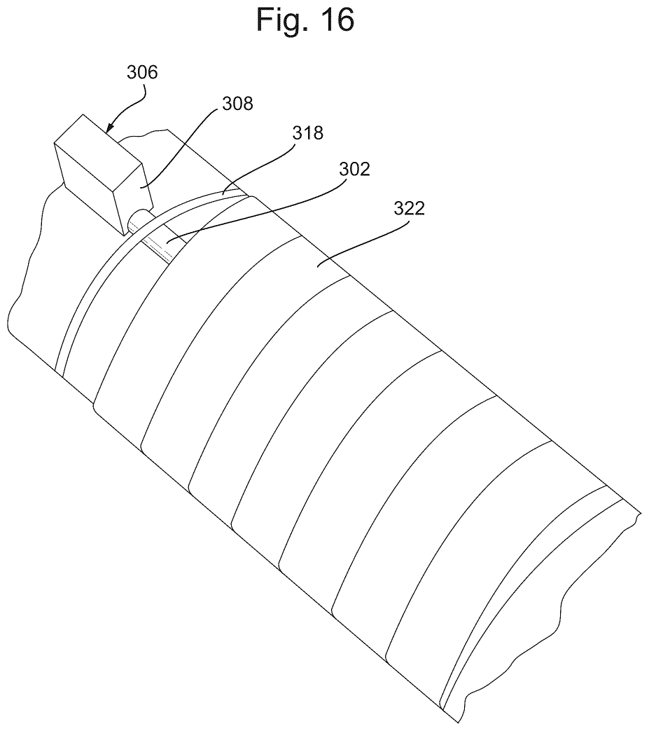

Next, and referring to FIG. 16 of the drawings, self-fusing or self-amalgamating tape 322 is wound around the pipe 316 (e.g. in the manner described above using the wrapping and tensioning device 500), over the putty 320 and extending beyond the putty at both ends of the repair region, such that all of the putty 320 is encapsulated with several overlapping layers of the stretched self-fusing tape 322. The pressure created by the tape 322 on the putty 320 beneath it acts to ‘squeeze’ and mould the putty, thus moulding it to the repair region. At this point, gas escaping from the leak will have nowhere to go except into the longitudinal channel through the base of the venting tool 300, entering the groove 310 in the bar 302 at its distal end, flowing through the groover 310 to the groove 312 in the block 306 and escaping through the open end of the groove 314 at the rear of the block 306.

Once a sufficient quantity of the self-fusing tape 322 has been applied, a hammer (or similar implement) can be used to remove the venting tool 300 from the repair (in the direction B) by repeatedly striking the face 308 of the block immediately adjacent and facing the bar 302 (in the direction B, i.e. a generally longitudinal direction relative to the pipe 316, in a direction away from the leak 314). It is likely to take a number of blows with a hammer to completely remove the venting tool 300 from the leak and, accordingly, the venting tool 300 will slide out of the repair in stages, with each strike of the hammer. Each time the venting tool 300 slides a little further out of the repair (in the direction B), the operative can press down the putty and tape in the region of the repair it has just vacated (at its distal end) to close the gap left behind.

Once the venting tool 300 has been completely removed, and the putty and tape pressed down over the repair, a puncture proof ‘armour’ can be applied (e.g. using water-activated glass fibre bandage or the like) to ensure that the repair is protected from damage.

It will be apparent to a person skilled in the art, from the foregoing description, that modifications and variations can be made to the described embodiments without departing from the scope of the invention as defined by the appended claims.

1.-45. (canceled)

46. A tape wrapping and dispensing device for wrapping stretchable tape around a pipe or other elongate body, the device comprising:
a support plate having a dispensing end and a lower edge defining a tape dispensing outlet region and an opposing distal end;
a carrier shaft, extending from said support plate between said dispensing and distal ends, on which a supply roll of stretchable tape can be rotatably mounted;
at least three rollers mounted at the dispensing end of the support plate, the tension rollers being configured in a generally rectangular arrangement and comprising a lower dispensing roller immediately adjacent said tape dispensing outlet region, an upper dispensing roller and an intermediate roller located adjacent to, and between, the upper and lower dispensing rollers such that the upper dispensing roller and the intermediate roller define a first nip and the intermediate roller and the lower dispensing roller define a second nip;
wherein, in use, the free end of the stretchable tape can be removed from the supply roll and passed, first, between the first nip and then between the second nip before being secured to a pipe or other elongate body, and then, with the lower dispensing roller in direct contact with the stretchable tape secured to the pipe or other elongate body, the device can be moved in a first circumferential direction around said pipe or other elongate body to cause rotation of said lower dispensing roller in said first circumferential direction and simultaneously dispense and wind the tape therearound;
the tension rollers being configured to grip the stretchable tape, in use, such that the device applies a tensile load to the stretchable tape and the stretchable tape dispensed from the tape dispensing outlet is under tension, and the lower dispensing roller acts to press the stretchable tape onto the pipe or elongate body as it is dispensed.

47. A tape wrapping and dispensing device according to claim 46, further comprising a take-up shaft for receiving the backing layer which is removed from the stretchable tape.

48. A tape wrapping and dispensing device according to claim 46, further comprising a handle member mounted at said dispensing end of said support plate.

49. A tape wrapping and dispensing device according to claim 46, wherein at least one of the rollers is resiliently or spring biased toward the other two rollers.

50. A tape wrapping and dispensing device according to claim 46, further comprising an adjustment mechanism which operates to adjust the relative position of at least one of the rollers relative to the other two rollers.

51. A tape wrapping and dispensing device according to claim 50, wherein said adjustment mechanism is configured to operate to adjust the relative position of the intermediate roller relative to the upper and lower dispensing rollers.

52. A tape wrapping dispenser according to claim 50, wherein said adjustment mechanism is configured to operate to adjust the relative position(s) of the upper and/or lower rollers relative to the intermediate roller.

53. A tape wrapping and dispensing device according to claim 50, wherein said adjustment mechanism comprises a selectively movable actuator configured to adjust the position of the shaft of one of the rollers relative to the other two rollers.

54. A tape wrapping and dispensing device according to claim 51, wherein the adjustment mechanism comprises an elongate selectively movable actuator mechanically coupled to the shaft of said intermediate roller, and an adjustment handle mechanically coupled to said movable actuator and configured to selectively move said shaft of said intermediate roller relative to said upper and lower rollers, and optionally wherein said adjustment handle is located adjacent the distal end of the support plate and said elongate actuator extends along said support plate from a location adjacent said adjustment handle to a location adjacent the shaft of said intermediate roller.

55. A tape wrapping and dispensing device according to claim 54, wherein said adjustment handle comprises a screw arrangement mechanically coupled to said elongate actuator and a rotatable adjustment handle coupled to said screw arrangement and operable to adjust the position of the intermediate roller.

56. A tape wrapping and dispensing device according to claim 46, further comprising a base roller mounted on the support plate adjacent its distal end and on the same edge as said tape dispensing outlet region, the base roller being arranged and configured such that, in use, the base roller can be placed in direct contact with the pipe or other elongate body, or previously wrapped layers of stretchable tape thereon, and caused to rotate in said first circumferential direction as the device is moved around the pipe in said first circumferential direction.

57. A tape wrapping and dispensing device according to claim 46, further comprising a handle arrangement mounted to the support plate at its distal end, and optionally wherein said handle arrangement comprises a pair of handle members mounted on said support plate and at least one of said handle members being selectively movable relative to the other handle member and/or the support plate.

58. A tape wrapping and dispensing device according to claim 46, further comprising a removable housing configured to be removably mountable to the support plate over at least said carrier shaft and said rollers.

59. A tape wrapping dispensing device according to claim 46, further comprising a housing hingedly mounted on the support plate over at least the carrier shaft and said rollers.

60. A high tension tape dispenser including a tape wrapping and dispensing device according to claim 46, and a supply roll of self-fusing tape mounted on the carrier shaft.

61. A method of wrapping a stretchable tape around a pipe or other elongate body, the method including:
taking a tape wrapping and tensioning device according to claim 46;
mounting a supply roll of stretchable tape onto the carrier shaft;
passing a free end of the stretchable tape, first, between said upper dispensing roller and said intermediate roller and then between the intermediate roller and the lower dispensing roller, before securing the free end of the stretchable tape to the surface of the pipe or elongate body;
positioning the device on the exterior surface of the pipe or elongate body such that the lower dispensing roller engages with the free end of the stretchable tape secured said exterior surface;
pulling the device in a first circumferential direction to dispense and stretch the tape, pressing the lower dispensing roller onto the stretchable tape as it is dispensed, and thus winding the tape around the pipe or elongate body; and
continuing to wrap the tape around the pipe in overlapping layers to cover a surface area of the pipe or elongate body.

62. A method according to claim 61, wherein said stretchable tape is a self-fusing or self-amalgamating tape.

63. A venting tool for use in a method of repairing a fluid leak in a fluid flow pipe, the venting tool comprising an elongate rigid bar having a proximal end and a longitudinally opposing distal end, the bar having a flat longitudinal base and an upper that tapers in height from said proximal to said distal end, the tool further comprising a rigid block at its proximal end, said block having a planar base substantially flush with the flat base of the bar and defining a striking surface adjacent to said proximal end and facing said bar, wherein a longitudinal groove or recess extends along the length of the base of the bar and the block.

64. A venting tool according to claim 63, wherein the depth of said groove or recess tapers from the proximal end of the bar to its distal end, and/or wherein the upper of said bar is rounded.
